(19) United States
(12) Patent Application Publication
(10) Pub. No.: US 2024/0150672 A1
(43) Pub. Date: May 9, 2024

(54) REMOVAL OF UNWANTED MINERAL OIL HYDROCARBONS

(71) Applicant: CARGILL, INCORPORATED, Wayzata, MN (US)

(72) Inventor: Maria Christina STEVERINK-DE ZOETE, Den Haag (NL)

(21) Appl. No.: 18/546,865

(22) PCT Filed: Feb. 14, 2022
(86) PCT No.: PCT/US2022/016259

§ 371 Date: Aug. 17, 2023

(30) Foreign Application Priority Data
Feb. 18, 2021 (EP) 21157986.7

(51) Int. Cl. C11B 3/06

(52) U.S. Cl. CPC C11B 3/06

(57) ABSTRACT

The present invention relates to a process for reducing the content of MOSH and/or MOAH in lauric oil, wherein the process is comprising the step of: a) Splitting a lauric oil into a fatty acid fraction and an aqueous glycerol fraction, b) purifying the fatty acid fraction from step a) into whole distilled lauric oil fatty acids, and c) esterifying the whole distilled lauric oil fatty acids from step b) and glycerol, and obtaining a MOSH and/or MOAH-reduced lauric oil.

### CROSS-REFERENCE TO RELATED APPLICATIONS

This application claims the benefit of European Application No. 21157986.7, filed 18 Feb. 2021, which is incorporated by reference herein in its entirety.

### FIELD OF THE INVENTION

The present invention relates to a novel process for reducing the content of MOSH and/or MOAH in lauric oils.

### BACKGROUND OF THE INVENTION

Mineral Oil Hydrocarbons (MOH) may be present as contaminants in oils and fats as well in foods prepared thereof. MOH are a complex mixture of molecules that are usually categorized into two main groups: Mineral Oil Saturated Hydrocarbons (MOSH) and Mineral Oil Aromatic Hydrocarbons (MOAH). MOSH are linear and branched (cyclo)alkanes. MOAH consists of highly alkylated mono/polycyclic aromatic hydrocarbons.

Contamination of food and feed products with MOH may occur through migration from materials in contact with food such as plastic materials, like polypropylene or polyethylene, recycled cardboard and jute bags. Contamination also occurs from the use of mineral oil-based food additives or processing aids and from unintentional contamination like for example from lubricants or exhaust gases from combustion engines.

From a health perspective, it is desirable to reduce, or even completely remove, MOSH and MOAH contamination from edible vegetable oils.

Crude oils, as extracted from their original source, are not suitable for human consumption due to the presence of impurities—such as free fatty acids, phosphatides, metals and pigments—which may be harmful or may cause an undesirable colour, odour or taste. Crude oils are therefore refined before use. The refining process typically consists of three major steps: degumming, bleaching and deodorizing. Optionally, a fourth step of chemical refining is included. An oil obtained after completion of the refining process (called a “refined oil” or more specifically a deodorized oil) is normally considered suitable for human consumption and may therefore be used in the production of any number of foods and beverages

Unfortunately, common refining processes are not effective to remove MOSH and/or MOAH in lauric oils. Stauff et. al. (https://doi.org/10.1002/ejlt.201900383—Eur. J. Lipid Sci. Technol. 2020, 1900383) is describing the removal of MOH from edible oils such as coconut oil, by means of a deodorization process. However, only a partial reduction of MOH could be achieved, whereby mainly the volatile subfraction having a carbon chain length below C24 is reduced.

There still is a need in the industry to identify an efficient and effective method for reducing MOSH and/or MOAH levels in vegetable oils. The present invention provides such a process.

### SUMMARY OF THE INVENTION

The present invention relates to a process for reducing the content of MOSH and/or MOAH in lauric oil, wherein the process is comprising the steps of:
a) Splitting a lauric oil into a fatty acid fraction and an aqueous glycerol fraction,
b) Purifying the fatty acid fraction from step a) into whole distilled lauric oil fatty acids, and
c) Esterifying the whole distilled lauric oil fatty acids from step b) and glycerol, and obtaining a MOSH and/or MOAH-reduced lauric oil.

### BRIEF DESCRIPTION OF THE FIGURE

FIG. 1 is a scheme of the process in accordance with the teachings of the present invention.

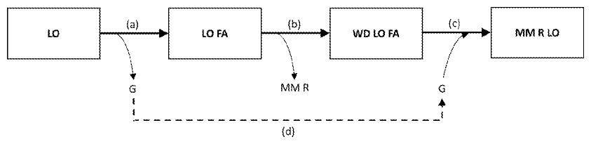

The following general legend is applied in FIG. 1:
Products or intermediate products are coded by acronyms (capital characters)
Arrows indicate the process flow. Arrows shown as bold/thick lines represent fixed process steps. Arrows shown as dashed lines represent optional process flows.
The performed process steps are indicated along the arrows and coded with a small characters (a to c).

Here follows the detailed description that is adhered to the acronyms in FIG. 1:
LO: lauric oil
LO FA: lauric oil fatty acids
WD LO FA: whole distilled lauric oil fatty acids
MM R LO: MOSH and/or MOAH-reduced lauric oil
G: glycerol
MM R: MOSH and/or MOAH-containing retentate
(a) Splitting a lauric oil into a fatty acid fraction and an aqueous glycerol fraction
(b) Purifying the fatty acid fraction from step a) into whole distilled lauric oil fatty acids
(c) Esterifying the whole distilled lauric oil fatty acids from step b) and glycerol
(d) Optional: using glycerol in step c) that is obtained by subjecting the aqueous glycerol fraction from step a) to a refining and concentration step.

### DETAILED DESCRIPTION

The present invention relates to a process for reducing the content of MOSH and/or MOAH in lauric oil, wherein the process is comprising the steps of:
a) Splitting a lauric oil into a fatty acid fraction and an aqueous glycerol fraction,
b) Purifying the fatty acid fraction from step a) into whole distilled lauric oil fatty acids, and
c) Esterifying the whole distilled lauric oil fatty acids from step b) and glycerol, and obtaining a MOSH and/or MOAH-reduced lauric oil.

### Laurie Oil as Starting Material

The term “oil” relates to a lipophilic substance that is substantially containing triglycerides, i.e. at least 90 wt. %, at least 95 wt. %, or at least 97 wt. % of triglycerides, expressed on total weight of the oil. The oil may further comprise mono- and diglycerides, as well as free fatty acids in a combined amount of less than 10 wt. %, less than 5 wt. %, or less than 3 wt. %, expressed on total weight of the oil.

The term “lauric oil” relates to an oil with a content of C6 to C12 fatty acids of more than 50%, whereby the content of fatty acids is referring to acids bound as acyl groups in glycerides in the oil.

Examples of such a lauric oil include coconut oil, palm kernel oil, babassu oil, cohune oil, tacum oil and cuphea oil or any mixture of two or more thereof. For the purposes of the present invention, the lauric oil will preferably be coconut oil and/or palm kernel oil, most preferably coconut oil

In one aspect of the invention, the vegetable lauric oil that is subjected to the short-path evaporation of the process is a degummed, bleached and/or deodorized lauric oil. Preferably the vegetable lauric oil is at least degummed.

Crude lauric oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and is subsequently sent without any separation of the phosphatides to the bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency.

Further, bleaching clays may be characterized based on their pH value. Typically, acid-activated clays have a pH value of 2.0 to 5.0. Neutral clays have a pH value of 5.5 to 9.0.

A skilled person will be able to select a suitable bleaching agent from those that are commercially available based on the oil being refined and the desired end use of that oil.

The bleaching step for obtaining the degummed and bleached lauric oil that is subjected to the fat-splitting step a) of the process, is performed at a temperature of from 80 to 115° C., from 85 to 110° C., from 90 to 105° C., or from 95 to 100° C., in presence of activated carbon and/or bleaching earth in an amount of from 0.2 to 5.0 wt %, from 0.5 to 3.0 wt %, or from 0.7 to 1.5 wt % on the weight of oil. Preferably, the bleaching earth is a neutral and/or natural bleaching earth.

Deodorization is a process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany; De Smet Group, S.A. of Brussels, Belgium; Gianazza Technology s.r.l. of Legnano, Italy; Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of 200 to 280° C., with temperatures of about 220-270° C. being useful for many oils. Typically, deodorization is thus occurring in a deodorizer whereby volatile components such as FFAs and other unwanted volatile components that may cause off-flavors in the oil, are removed. Deodorization may also result in the thermal degradation of unwanted components.

In one more aspect of the invention, the lauric oil that is subjected to the fat-splitting step a) of the process is a degummed and bleached lauric oil, and a method for obtaining the degummed and bleached lauric oil is comprising the steps of:
i) Degumming and obtaining a degummed lauric oil,
ii) Bleaching the degummed oil from step i)
   at a temperature of from 80 to 115° C., from 85 to 110° C., from 90 to 100° C., or 95 to 105° C.,
   with bleaching earth in an amount of from 0.2 to 5.0 wt %, from 0.5 to 3.0 wt %, or from 0.7 to 1.5 wt % on the weight of the oil, and obtaining a degummed and bleached oil, and
iii) Optionally deodorizing the degummed and bleached oil from step ii).

The lauric oil that is subjected to the fat-splitting step a) of the process may have a content of MOSH of 20 ppm or higher, 40 ppm or higher, 60 ppm or higher, or even 80 ppm or higher. The content of MOAH may be more than 2 ppm or higher, more than 5 ppm or higher, more than 10 or higher, more than 20 ppm or higher, more than 40 ppm or higher, or even more than 60 ppm or higher.

Step a)—Subjecting the Lauric Oil to Fat-Splitting

In step a) of the process according to the invention, the lauric oil is subjected to a fat-splitting.

There are at least four well-known fat-splitting processes that can be applied in step a) of the current invention. The Twitchell process is a somewhat archaic process operated at atmospheric pressure. The batch autoclave process and the continuous counter-current process (also known as Colgate-Emery process) are processes operated under pressure. The fourth process is an enzymatic process wherein fats and/or oils are hydrolysed using lipase enzymes.

In one aspect of the invention, the fat-splitting step is a continuous counter-current process. The counter-current process is operated at a pressure in a range of from 30 to 70 bar, from 35 to 65 bar, from 40 to 60 bar, or from 45 to 55 bar, and a temperature in a range of from 210 to 270° C., from 220 to 265° C., from 225 to 260° C., or from 230 to 250° C. A catalyst such as, but not limited to, zinc, magnesium or calcium oxide, may be used. Preferably, the continuous counter-current process is operated in the absence of a catalyst.

In an alternative aspect of the invention, the fat-splitting step is an enzymatic step. The step may be carried out by contacting the lauric oil and water with one or more lipases in native (soluble) form or in immobilized form. The enzymatic splitting step is performed at a temperature in a range of from 25 to 70° C., from 30 to 60° C., or from 35 to 55° C. The temperature at which the enzymatic splitting step is performed is dependent on the optimal temperature range of the enzyme used. The process may be batchwise or continuously. At the end of the reaction an oily phase (=the fatty acid fraction) is obtained containing triglyceride and fatty acids, and an aqueous phase (=the aqueous glycerol fraction) containing glycerol and lipase.

An non-exhaustive, non-limiting list of suitable lipases includes lipase derived from Candida cylindracea, Candida lipolytica, Candida rugosa, Candida antarctica, Candida utilis, Chromobacterium viscosum, Geotrichum viscosum, Geotrichum candidum, Mucor javanicus, Mucor miehei, Pseudomonas species, specifically P. fluorescens, P. cepacia, P. pseudoalkaligenes, P. alkaligenes, Thermomyces species, Rhizopus arrhizus, Rhizopus delemar, Rhizopus niveus, Rhizopus oryzae, Rhizopus javanicus, Aspergillus niger, Penicillium roquefortii, Penicillium camembertii or an esterase derived from Bacillus species, specifically B. thermoglucosidasius, or combinations thereof.

The fatty acid fraction is comprising mainly the fatty acids split from the lauric oil. It may also contain water-insoluble contaminants that were present in the lauric oil, such as, but not limited to MOSH and/or MOAH, polycyclic aromatic hydrocarbons (PAH), oxidized fatty acids, odour and colour compounds.

The aqueous glycerol fraction, also known as sweetwater, is containing up to 20% of glycerol.

Step b)—Purifying the Fatty Acids from Step a)

In step b) of the process according to the invention, the fatty acid fraction from step a) is subjected to a purification step.

In one aspect of the invention, the purification in step b) of the process is a distillation performed at a pressure in a range of from 2 to 30 mbar, from 5 to 25 mbar, or from 8 to 20 mbar.

Furthermore, the purification in step b) of the process is a distillation performed at a temperature in a range of from 150 to 250° C., from 155 to 220° C., or from 160 to 190° C.

Distillation units for fatty acid distillation are known in the art. Examples of such fatty acid distillation units are Badger's or Lurgi's continuous fatty acid distillation plants.

In the purification step b) of the process, at least two fractions are obtained from the fatty acid distillation: a retentate and a distillate. Optionally, a third fraction is obtained, i.e. a top fraction, that is containing about 1% of the weight of all distillation fractions and is mainly containing volatile odour and/or colour compounds.

The distillate is comprising whole distilled lauric oil fatty acids. The term “whole distilled lauric oil fatty acids” refers to a distillate of fatty acids of lauric oil having a composition of fatty acids that is substantially identical to the fatty acid profile, i.e. the fatty acids bound as acyl groups in glycerides, of the lauric oil that was used in step a) of the process.

For each of the fatty acids selected from the group of C8, C10, C12, C14, C16 and C18.1, the percentual difference of the amount of that fatty acid in the whole distilled lauric oil fatty acids versus the amount of the corresponding fatty acid bound as acyl group in glycerides in the lauric oil that is used in step a) of the process, will deviate with less than 10%, less than 5%, or even less than 2%.

The purification in step b) of the process according to the invention results in whole distilled lauric oil fatty acids having a reduced content of MOSH and/or MOAH and a retentate having an elevated content of MOSH and/or MOAH, compared to the lauric oil that is subjected to step a) of the process. The purification in step b) of the process may further result in whole distilled lauric oil fatty acids having a reduced content in PAH.

The process according to the invention does not comprise a step of fractional distillation of the fatty acid fraction from step a). Fractional distillation of the fatty acid fraction makes it possible to separate fatty acids fractions according to their molecular weight. Example of such fractions would be C8-C10 fractions, C12-C14 fractions or the like. In these fractions there is a significant percentual difference of the amount of that fatty acid versus the amount of the corresponding fatty acid bound as acyl group in glycerides in the lauric oil.

Step c)—Esterifying Distilled Fatty Acids and Glycerol

In step c) of the process according to the invention, an esterification reaction between the whole distilled lauric oil fatty acids from step b) and glycerol is performed. A MOSH and/or MOAH-reduced lauric oil is obtained.

The esterification reaction between the whole distilled lauric oil fatty acids from step b) and glycerol may be obtained by means of a chemical process or an enzymatic process. During the reaction process, whether chemical or enzymatic, water is to be removed from the reaction in order to increase the yield of lauric oil.

Chemical esterification is performed at reduced pressure, not higher than 5 mbar and high temperature, up to 260° C. The chemical esterification is performed in the presence of a catalyst. Catalysts may be acid catalysts, such as for example to sulfuric acid, alkaline catalysts such as for example sodium methoxide, or metal oxides such a calcium oxide.

Alternatively, esterification may be obtained by means of an enzymatic reaction in the presence of lipases. An non-exhaustive, non-limiting list of suitable lipases includes lipase derived from Candida cylindracea, Candida lipolytica, Candida rugosa, Candida antarctica, Candida utilis, Chromobacterium viscosum, Geotrichum viscosum, Geotrichum candidum, Mucor javanicus, Mucor miehei, Pseudomonas species, specifically P. fluorescens, P. cepacia, P. pseudoalkaligenes, P. alkaligenes, Thermomyces species, Rhizopus arrhizus, Rhizopus delemar, Rhizopus niveus, Rhizopus oryzae, Rhizopus javanicus, Aspergillus niger, Penicillium roquefortii, Penicillium camembertii or an esterase derived from Bacillus species, specifically B. thermoglucosidasius, or combinations thereof.

In one aspect of the invention, the glycerol that is used in step c) is obtained by subjecting the aqueous glycerol fraction from step a) to a further treatment step.

The further treatment step may comprise a first purification to remove non-glycerol substances by precipitation and filtration, a subsequent removal of water from the aqueous glycerol fraction and a second purification by distillation

Various chemicals may be used in the first purification step of the aqueous glycerol fraction such as, but not limited to, lime, aluminium salts, sodium hydroxide, ferric chloride, hydrogen chloride, and mixtures of two of more thereof. The chemicals react with the impurities in the aqueous glycerol fraction and form a precipitate. This precipitate is removed by means of filtration. Subsequently water is removed from the aqueous glycerol fraction by means of evaporation. The glycerol is then further purified by means of distillation.

Alternatively, the further treatment of the aqueous glycerol fraction may be by means of ion exchange followed by evaporation.

The glycerol that is obtained by subjecting the aqueous glycerol fraction from step a) to a further treatment step, has a level of purity of more than 99%.

The Lauric Oil Obtained from Process Steps a) to c)

The process steps a) to c) of the present invention result in a MOSH and/or MOAH-reduced lauric oil having a content of MOSH and/or MOAH that is reduced for at least 25%, at least 30%, at least 40%, at least 50%, at least 55%, at least 60%, at least 65%, at least 70% or even at least 80%, compared to the lauric oil in step a) that is subjected to the process.

The method that is used to measure the content of MOSH as well as the content of MOAH is method DIN EN 16995:2017 (as part of CEN/TC275/WG 13). The “content of MOSH” is defined as the total amount of saturated hydrocarbons (MOSH) with a carbon chain length in a range of C10 to C50. The “content of MOAH” is defined as the total amount of aromatic hydrocarbons (MOAH) with a carbon chain length in a range of C10 to C50.

More specifically, the process steps a) to c) of the present invention result in a reduction of the heavy MOSH and/or heavy MOAH content in the lauric oil for at least 40%, at least 50%, at least 55%, at least 60%, at least 65%, at least 70%, at least 80%, or even at least 90%, compared to the lauric oil of step a) that is subjected to the process.

The method that is used to measure the content of heavy MOSH as well as the content of heavy MOAH is method DIN EN 16995:2017 (as part of CEN/TC275/WG 13). The “content of heavy MOSH” is defined as the total amount of saturated hydrocarbons (MOSH) with a carbon chain length of more than C35 and less or equal than C50. The “content of heavy MOAH” is defined as the total amount of aromatic hydrocarbons (MOAH) with a carbon chain length of more than C35 and less or equal than C50.

For each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process will deviate with less than 10%, less than 5%, or even less than 2%.

Existing processes for splitting of lauric oils are applied to use the fatty acids as starting material for further reactions or further fractionation. In such processes fatty acids are obtained with the purpose of transforming these fatty acids further into oleochemicals such as fatty acid esters, fatty acid ethoxylates, conjugated fatty acids or fatty alcohols. The end products are significantly different from the lauric oil that was used as starting oil either in terms of chemical functionality or at least in terms of fatty acid profile of the resulting fraction. The process of the present invention is aiming to end-up with a lauric oil having the same or substantially the same fatty acid profile as the starting material.

Furthermore, while in step b) of the current process whole distilled lauric oil fatty acids are obtained, it should be clear that they are different and should not be confused with existing products commonly known as CFAD (coconut fatty acid distillate) or PKFAD (palm kernel fatty acid distillate). Such existing fatty acid distillates are obtained as a by-product from the refining, more specifically from the deodorization, of the lauric oils whereby steam is removing volatiles such as fatty acids but also other volatile impurities from the refined oil into the distillate. The resulting fatty acid distillate do not have a reduced content of volatile contaminants such as MOSH and/or MOAH having a carbon chain length lower than C24. This low value by-product is therefore often used in non-food applications such as biodiesel production. The whole distilled lauric oil fatty acids obtained in step b) of the current process is having a reduced content of MOSH and/or MOAH.

It has thus been found that by combining the splitting of a lauric oil into fatty acids followed by purifying the fatty acids and esterifying these fatty acids with glycerol, the MOSH and/or MOAH content in the lauric oil is reduced. The fatty acid profile of the resulting oil is the same or maintains substantially the same fatty acid profile as the starting lauric oil.

Further Refining of the MOSH and/or MOAH Reduced Lauric Oil

In one aspect of the invention, the process is comprising a step of deodorization of the MOSH and/or MOAH-reduced lauric oil obtained from step c). A deodorized MOSH and/or MOAH-reduced lauric oil is obtained.

In one aspect of the invention, the step of deodorization of the MOSH and/or MOAH-reduced lauric oil from step c) is carried out at a temperature in a range of from 260 to 190° C., from 240 to 200° C., or from 220 to 210° C.

Further, the deodorization the MOSH and/or MOAH-reduced lauric oil from step c) is carried out in the presence of sparge steam in an amount of from 0.1 to 2.0 wt %, from 0.2 to 1.5 wt %, from 0.3 to 1.0 wt %, or from 0.4 to 0.8 wt % based on amount of oil.

Furthermore, the step of deodorization the MOSH and/or MOAH-reduced lauric oil from step c) is carried out at an absolute pressure of 10 mbar or less, 7 mbar or less, 5 mbar or less, 3 mbar or less, 2 mbar or less.

The step of deodorization of the MOSH and/or MOAH-reduced lauric oil from step c) may result in a further reduction of the content of MOSH and/or MOAH, a removal of remaining free fatty acids and/or an improvement of the flavour of the deodorized MOSH and/or MOAH-reduced lauric oil.

Specifically, the step of deodorization of the MOSH and/or MOAH-reduced lauric oil from step c) may result in a reduction of the content of light MOSH and/or light MOAH in the lauric oil for at least 40%, at least 50%, at least 55%, at least 60%, at least 65%, at least 70%, at least 80%, or even at least 90%, compared to the lauric oil from step a) that was subjected to the process

The method that is used to measure the content of light MOSH as well as the content of light MOAH is method DIN EN 16995:2017 (as part of CEN/TC275/WG 13). The “content of light MOSH” is defined as the total amount of saturated hydrocarbons (MOSH) with a carbon chain length in a range of C10 to C35, preferably in a range of from C10 to C25.

The “content of light MOAH” is defined as the total amount of aromatic hydrocarbons (MOAH) with a carbon chain length in a range of C10 to C35, preferably in a range of from C10 to C25.

The deodorized MOSH and/or MOAH-reduced lauric oil has a content of free fatty acids (FFA) of below 0.10%, below 0.08%, or below 0.05%, expressed as lauric acid and measured according to AOCS method Ca 5a-40.

The deodorized MOSH and/or MOAH-reduced lauric oil has an overall flavour quality score (taste), according to AOCS method Cg 2-83, in a range of from 7 to 10, or from 8 to 10, or from 9 to 10 (with 10 being an excellent overall flavour quality score and 1 being the worst score).

In one preferred aspect, the step of deodorization the MOSH and/or MOAH-reduced lauric oil from step c) of the present process is carried out at a temperature in a range of from 190 to 220° C., from 195 to 215° C., or from 200 to 210° C. This further refining at a temperature in a range of from 190 to 220° C. may result in a deodorized MOSH and/or MOAH-reduced lauric oil that has a reduced content of MCPDE and/or GE. MCPDE, including 3-monochloropropane-1,2-diol fatty acid esters (3-MCPD esters), 2-chloro-1,3-propanediol fatty acid esters (2-MCPD esters) and GE (glycidyl esters) are contaminants that are typically being formed as a result of oils being exposed to high temperatures during oil processing, in particular during deodorization.

The GE content of the deodorized MOSH and/or MOAH-reduced lauric oil is below 1.0 ppm, below 0.8 ppm, below 0.5 ppm, below 0.3 ppm, below 0.1 ppm, or below LOQ (limit of quantification). The content of MCPDE of the deodorized MOSH and/or MOAH-reduced lauric oil is below 2.5 ppm, below 2.2 ppm, below 2.0, below 1.9 ppm, below 1.8 ppm, below 1.5 ppm, below 1.2 ppm, below 1.0 ppm, below 0.8 ppm, below 0.5 ppm, or below 0.3 ppm.

The content of GE and/or MCPDE is measured with Method DGF Standard Methods Section C (Fats) C-VI 18(10).

Further Bleaching of the MOSH and/or MOAH Reduced Lauric Oil

In another aspect of the invention, the MOSH and/or MOAH-reduced lauric oil from step c) is subjected to a bleaching step prior to the deodorization of the lauric oil obtained from step c). A bleached and deodorized MOSH and/or MOAH-reduced lauric oil is obtained.

During the bleaching step the MOSH and/or MOAH-reduced lauric oil from step c) is contacted with an absorbent.

The adsorbent can be selected from bleaching agent, activated carbon, zeolite, exchange resin, silica and/or two or more combinations thereof. Examples of silica that can be employed in the present process include magnesium silicate, calcium silicate, aluminium silicate and combinations thereof. The activated carbon is preferably acidic activated carbon. The exchange resin is preferably a cation exchange resin. The bleaching agent can be neutral or activated bleaching agent. Activated bleaching agent refers to acid and/or physically activated (e.g. by thermal treatment). Activation includes the increase of the surface in order to improve the bleaching efficiency. Preferably an acid activated bleaching agent is applied.

The amount of adsorbent is in the range of from 0.3 to 4.0 wt % by weight of oil, in the range from 0.4 to 3.0 wt %, from 0.5 to 2.5 wt %, from 0.6 to 2.0 wt %, from 0.7 to 1.5 wt %, or from 0.8 to 1.2 wt %.

The temperature at which the MOSH and/or MOAH-reduced lauric oil from step c) is contacted with the adsorbent is in the range of from 70 to 120° C., from 80 to 110° C., or from 85 to 100° C.

The contact time of the MOSH and/or MOAH-reduced lauric oil from step c) with the adsorbent is in a range of from 15 to 60 minutes, from 20 to 50 minutes, or from 30 to 45 minutes. The bleached oil is subsequently separated from the adsorbent.

The contacting of the MOSH and/or MOAH-reduced lauric oil obtained from step c) with an adsorbent, may result, amongst others, in a lowering of the colour of the MOSH and/or MOAH-reduced lauric oil.

In one aspect of the invention, the bleached and deodorized MOSH and/or MOAH-reduced lauric oil that is obtained from the process is characterized by a Lovibond red colour of 1.5R or less, 1.2R or less, 1.0R or less and/or a Lovibond yellow colour of 15Y or less, 12Y or less, 10Y or less, (measured in a 5¼ inch glass measuring cell according to AOCS method Cc13e-92).

In one aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a).

In another aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a), and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process, will deviate with less than 10%, less than 5%, or even less than 2%.

In a one more aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a),
wherein the glycerol that is used in step c) is obtained by subjecting the aqueous glycerol fraction from step a) to a refining and concentration step, and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process, will deviate with less than 10%, less than 5%, or even less than 2%.

In yet another aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a), and
wherein the glycerol that is used in step c) is obtained by subjecting the aqueous glycerol fraction from step a) to a refining and concentration step, and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process, will deviate with less than 10%, less than 5%, or even less than 2%, and
wherein the lauric oil is coconut oil.

In another aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a), and
wherein the process is comprising a step of deodorization of the lauric oil obtained from step c), and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process will deviate with less than 10%, less than 5%, or even less than 2%.

In one more aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a), and
wherein the process is comprising a step of deodorization of the lauric oil obtained from step c), and the oil obtained in step c) is subjected to a bleaching step prior to the deodorization step, and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process, will deviate with less than 10%, less than 5%, or even less than 2%.

In yet another aspect of the invention, the process for reducing the content of MOSH and/or MOAH in lauric oil is comprising the steps of:
a) Splitting a lauric oil into a fatty acid fraction and an aqueous glycerol fraction,
b) Purifying the fatty acid fraction from step a) into whole distilled lauric oil fatty acids,
c) Esterifying the whole distilled lauric oil fatty acids from step b) and glycerol, and obtaining a MOSH and/or MOAH-reduced lauric oil,
wherein the lauric oil that is subjected to the fat-splitting step a) is degummed and/or bleached prior to step a),
wherein the glycerol that is used in step c) is obtained by subjecting the aqueous glycerol fraction from step a) to a refining and concentration step, and
wherein the process is comprising a step of deodorization of the lauric oil obtained from step c), and
wherein the oil obtained in step c) is subjected to a bleaching step prior to the deodorization step, and
wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process, will deviate with less than 10%, less than 5%, or even less than 2%, and
wherein the lauric oil is coconut oil.

1. A process for reducing the content of MOSH and/or MOAH in lauric oil, wherein the process is comprising the steps of:
a) Splitting a lauric oil into a fatty acid fraction and an aqueous glycerol fraction,
b) Purifying the fatty acid fraction from step a) into whole distilled lauric oil fatty acids, and
c) Esterifying the whole distilled lauric fatty acids from step b) and glycerol, and obtaining a MOSH and/or MOAH-reduced lauric oil.

2. The process according to claim 1, wherein the glycerol that is used in step c) is obtained by subjecting the aqueous glycerol fraction from step a) to a further treatment step.

3. The process according to claim 1, wherein the lauric oil that is subjected to the fat-splitting step a) is a degummed, bleached and/or deodorized lauric oil.

4. The process according to claim 1, wherein the lauric oil that is subjected to the fat-splitting step a) is a degummed and bleached lauric oil.

5. The process according to claim 1, wherein the lauric oil is a coconut oil.

6. The process according to claim 1, wherein the process is comprising a step of deodorization of the lauric oil obtained from step c).

7. The process according to claim 6, wherein the MOSH and/or MOAH-reduced lauric oil from step c) is subjected to a bleaching step prior to the deodorization of the lauric oil obtained from step c).

8. The process according to claim 1, wherein for each of the fatty acids selected from the group of C8, C10, C12, C14, C16 and C18.1, the percentual difference of the amount of that fatty acid bound as acyl group in glycerides in the MOSH and/or MOAH-reduced lauric oil that is obtained from step c) versus the amount of the corresponding fatty acid bound as acyl group in glycerides in the lauric oil that was used in step a) of the process will deviate with less than 10%, less than 5%, or even less than 2%.
